(19) United States
(12) Patent Application Publication
(10) Pub. No.: US 2026/0160623 A1
(43) Pub. Date: Jun. 11, 2026

(54) METAL MEMBER FOR PRESSURE SENSOR

(71) Applicant: TDK CORPORATION, Tokyo (JP)

(72) Inventors: Tetsuo HATA, Tokyo (JP); Takashi AOYAGI, Tokyo (JP); Ken UNNO, Tokyo (JP); Tetsuya SASAHARA, Tokyo (JP); Masanori KOBAYASHI, Tokyo (JP); Lucie OUEDRAOGO, Tokyo (JP)

(73) Assignee: TDK CORPORATION, Tokyo (JP)

(21) Appl. No.: 19/077,158

(22) Filed: Mar. 12, 2025

(30) Foreign Application Priority Data
Mar. 28, 2024 (JP) 2024-055027

(51) Int. Cl. G01L 9/00

(52) U.S. Cl. CPC G01L 9/0002

(57) ABSTRACT

A metal member for a pressure sensor, including: a base wall and a side wall extending in a direction which crosses the base wall; wherein an outer base surface of the base wall includes an outer base surface side wall area which overlies with the side wall in plan view, and an outer base surface inner side wall area which is positioned inside of and in contact with the outer base surface side wall area and does not overlie the side wall in plan view; and the outer base surface inner side wall area includes, in plan view, a protruding part existing outside of a maximum circle which can be arranged in the outer base surface inner side wall area in plan view.

### CROSS-REFERENCE TO RELATED APPLICATIONS

This application claims priority to Japanese patent application No. 2024-055027 filed on Mar. 28, 2024 which is incorporated herein by reference in its entirety.

The present disclosure relates to a metal member for a pressure sensor which is also called a stem, or so.

### BACKGROUND

As a sensor such as a pressure sensor, a technology which forms a resistance wiring on a base surface of a metal member such as a stem or so has been proposed (see Patent Document 1).

In regards with the metal member used for the pressure sensor, in order to ensure strength of the metal member during pressure detection, a metal member having a thicker side wall has been proposed.

### PRIOR ART DOCUMENT

### Patent Document 1

JP Patent Laid Open No. H11-37877

### SUMMARY

A metal member for a pressure sensor according to the present disclosure includes:
a base wall and a side wall extending in a direction which crosses with the base wall;
wherein an outer base surface of the base wall includes an outer base surface side wall area which overlies with the side wall in plan view, and an outer base surface inner side wall area which is positioned inside of and in contact with the outer base surface side wall area and does not overlie the side wall in plan view; and
the outer base surface inner side wall area includes a protruding part existing outside from a maximum circle which can be arranged in the outer base surface inner side wall area in plan view.

### BRIEF DESCRIPTION OF DRAWINGS

FIG. 1 is an exterior view of a metal member for a pressure sensor according to the first embodiment.

FIG. 2 is a cross-sectional perspective view of the metal member for the pressure sensor shown in FIG. 1.

FIG. 3 is a plan view of the metal member for the pressure sensor shown in FIG. 1.

FIG. 4 shows a simulation result of a degree of strain caused in the metal member for the pressure sensor according to the first embodiment.

FIG. 5 is an exterior view of a metal member main body according to the second embodiment.

FIG. 6 is an exterior view of a metal member main body according to the third embodiment.

FIG. 7 is an exterior view of a metal member main body according to the fourth embodiment.

FIG. 8 is an exterior view of a metal member main body according to the fifth embodiment.

FIG. 9 is an exterior view of a metal member main body according to the sixth embodiment.

FIG. 10 is a graph comparing a degree of strain of a protruding part of the metal member of the pressure sensor according to each example and comparative example including the examples shown in FIG. 1 to FIG. 6.

### DETAILED DESCRIPTION

In regards with a conventional metal member, when the side wall of the metal member is made thinner, strain of an outer area of the metal member during the pressure detection becomes larger; hence, strength of the metal member during the pressure detection may not be sufficient enough. Also, when the side wall of the metal member is thickened, weight and also a material cost increase.

It is desirable to provide a metal member for a pressure sensor capable of maintaining strength of the side wall and achieving thinner side wall.

In below, the present disclosure is described based on the embodiments shown in the figures.

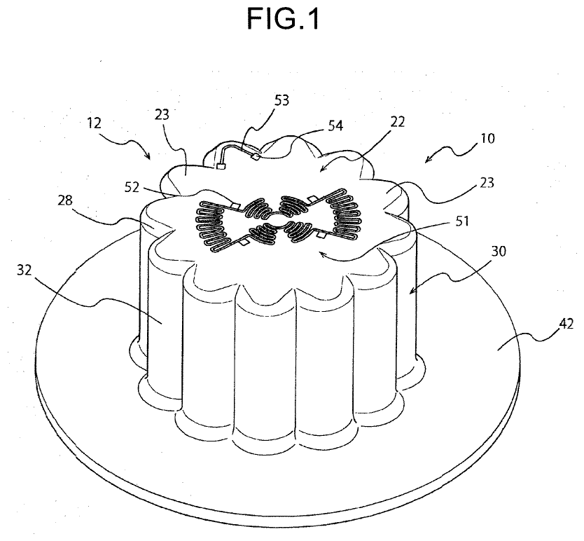

FIG. 1 is a schematic perspective view of a metal member 10 for a pressure sensor according to an embodiment of the present disclosure. As shown in FIG. 1, the metal member 10 includes a metal member main body 12, a first resistance wiring 51, a second resistance wiring 53, etc.

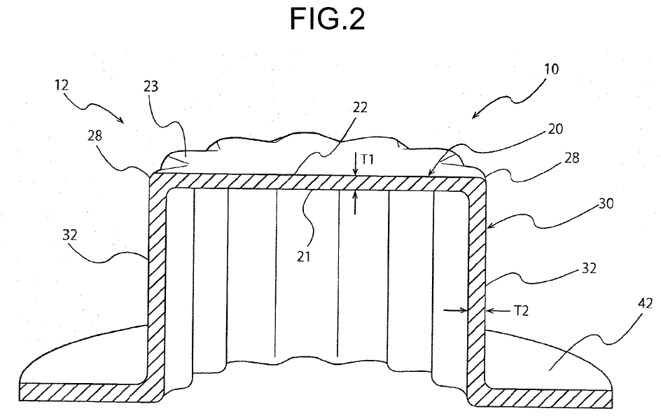

FIG. 2 is a cross-sectional perspective view of the metal member 10 shown in FIG. 1. In FIG. 2, the first resistance wiring 51, the second resistance wiring 53, etc., are not shown, and only the metal member main body 12 of the metal member 10 is shown. As shown in FIG. 2, the metal member main body 12 includes a base wall 20, and a side wall 30 extending in a direction crossing the base wall 20. At the inside of the metal member 10, a hallow part surrounded by the base wall 20 and the side wall 30 is formed.

As shown in FIG. 2, the base wall 20 is connected so as to cover one side of the tubular shaped side wall 30 (in FIG. 2, an upper side is covered); and, the base wall 20 and the side wall 30 form a tube shape with a bottom. Also, the other side of the side wall 30 (the lower side in FIG. 2) is an open end which connects to a hollow part of the base wall 20 formed inside of the metal member 10. The direction that the side wall 30 extends may be approximately perpendicular to the direction which the outer base surface of the base wall 20 extends; however, the side wall 30 may be slanted so that the hollow part becomes wider towards the open side from the base wall 20 side.

Part of the base wall 20 (particularly an inner side area 25 which is described later) is a membrane generating strain due to fluid pressure as a target to be measured. A flange part 42 of a ring form is connected to the other side of the side wall 30 (the lower side in FIG. 2).

The metal member 10 shown in FIG. 1 and FIG. 2, for example, is installed so as to seal the opening formed to the fluid passage filled with fluid which is a target to be measured; and then, it is used as a pressure sensor. Strain of the base wall 20 caused by the fluid pressure acting on a base wall inner surface 21 of the base wall 20 shown in FIG. 2 is detected by the first resistance wiring 51 (see FIG. 1) provided on the outer base surface.

The metal member main body 12 is configured of metals such as stainless steel, etc.

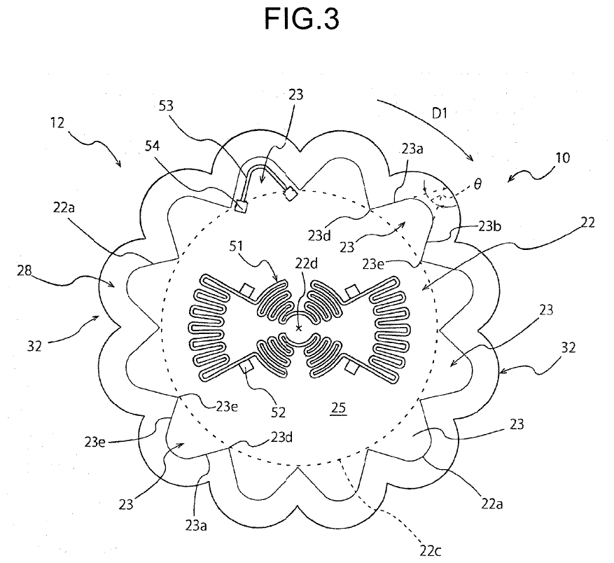

FIG. 3 is a plan view of the metal member 10 shown in FIG. 1. As shown in FIG. 3, the outer base surface of the base wall 20 includes an outer base surface inner side wall area 22 and an outer base surface side wall area 28 at the inside of the side wall outer surface 32 of the side wall 30 in plan view. The outer base surface side wall area 28 is an area which overlies the side wall 30 in plan view. In plan view, the outer base surface inner side wall area 22 is an area positioned at the inside of the outer base surface side wall area 28 and also in contact with the outer base surface inner side wall area 28; and the outer base surface inner wall area 22 is also an area which does not overlie the side wall 30.

As shown in FIG. 1 and FIG. 3, the outer base surface inner side wall area 22 extends to an area including a center part of the end face (outer base surface) of the metal member 10 configured of the outer base surface inner side wall area 22 and the outer base surface side wall area 28. As shown in FIG. 2, the outer base surface is a surface of the base wall 20 (the outer base surface inner side wall area 22) which is facing away from the base wall inner surface 21.

As shown in FIG. 3, a center of gravity (a geometric center) 22d of the outer base surface inner side wall area 22 in a plan shape approximately coincides with a center of gravity of the end face (outer base surface) of the metal member 10 configured of the outer base surface inner side wall area 22 and the outer base surface side wall area 28. The outer base surface side inner side wall area 22 includes a protrusion part 23 existing outside of a maximum circle 22c which can be arranged in the outer base surface inner side wall area 22 in plan view, and an inner area 25 existing on the maximum circle 22c and inside thereof in plan view. Note that, this maximum circle is a hypothetical circle. In the example shown in FIG. 3, the center of the maximum circle 22c coincides with the center of gravity 22d.

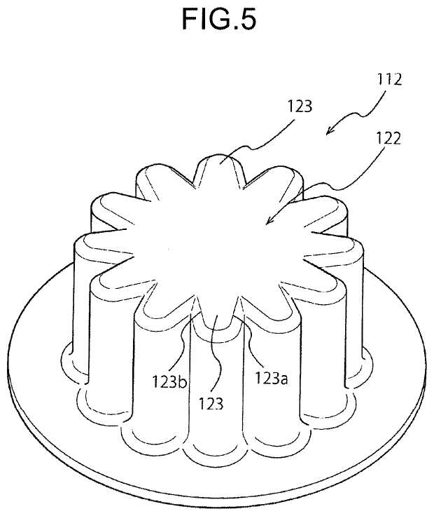

The outer base surface inner side wall area 22 of the outer base surface of the metal member 10 shown in FIG. 3 has one inner area 25 and twelve protruding parts 23. The twelve protruding parts 23 are arranged in an equal pitch (30-degree pitch) between each other along the first rotating direction D1 which a center is the center of the maximum circle 22c. Note that, the number of the protruding parts 23 provided to the outer base surface inner side wall area 22 is not limited to twelve, and it can be any number of one or larger (see the second to sixth examples, etc., shown in FIG. 5 to FIG. 9). Note that, the first rotating direction D1 is defined as a clockwise direction as shown in FIG. 3.

Each protruding part 23 exists between an angle range from a first contact point 23d to a second contact point 23e in the first rotating direction D1; in which the first contact point 23d is one of the contact points between the maximum circle 22c and an outline 22a of the outer base surface inner side wall area 22, and the second contact point 23e is one of the other contact points between the maximum circle 22c and the outline 22a and also the adjacent contact point to the first contact point 23d.

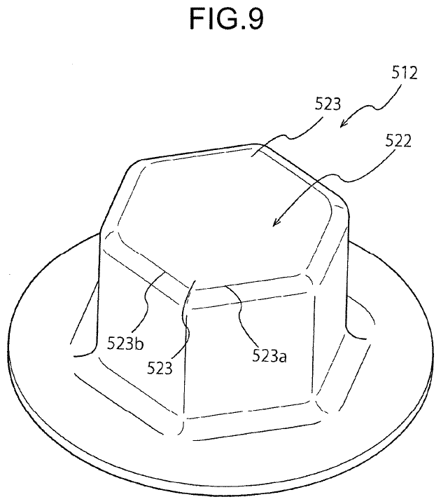

Also, each protruding part 23 has a first side 23a and a second side 23b; in which the first side 23a extends in a direction away from the maximum circle 22c along the first rotating direction D1 having a center coinciding with the center of the maximum circle 22c and the second side 23b extends in a direction approaching towards the maximum circle 22c along the first rotating direction. From the point of effectively reducing the degree of strain generated in the protruding part 23 and the surrounding area thereof, and also from the point of securing a radius direction width of the protruding part 23 from the center of the maximum circle 22c, the protruding part 23 may have an included angle formed between the first side 23a and the second side 23b of 90 degrees or smaller. Note that, the included angle between the first side 23a and the second side 23b may be 90 degrees or larger (see FIG. 9).

Also, from the point of easy production of the metal member 10 using a mechanical processing, etc., and also from the point of securing the rotating direction width of the protruding part 23 having a center coinciding with the center of the maximum circle 22c, the protruding part 23 may have the included angle formed between the first side 23a and the second side 23b of 10 degrees or larger. Note that, in FIG. 3, the included angle θ between the first side 23a and the second side 23b of the protruding part 23 is 60 degrees.

As shown in FIG. 3, the outer base surface side wall area 28 is in contact with the outline 22a of the outer base surface inner side wall area 22, and it is formed in a belt form which surrounds outside of the outer base surface inner side wall area 22. As shown in FIG. 1 to FIG. 3, the outer base surface side wall area 28 connects the outer base surface inner side wall area 22 and a side wall outer surface 32. The outer base surface side wall area 28 is configured of a curved surface, a flat surface, or a combination of curved surface and flat surface which faces an outer direction between a facing direction of the outer base surface inner side wall area 22 and a facing direction of the side wall outer surface 32. The outer base surface side wall area 28 may be configured of the flat surface continuous with and extending in the same direction of the outer base surface inner side wall area 22. In plan view, protrusions extending in the outer diameter direction, as similar to the outline 22a of the outer base surface inner side wall area 22, are also formed in the outer base surface side wall area 28 periodically along the first rotating direction D1. In plan view, protrusions extending in the outer diameter direction, as similar to the outline 22a of the outer base surface inner side wall area 22, are also formed at the side wall outer surface 32 where the outside of the outer base surface side wall area 28 connects.

As shown in FIG. 1 and FIG. 3, the metal member 10 includes the first resistance wiring 51 which detects strain of the base wall 20, and the second resistance wiring 53 which detects the temperature of the base wall 20. As shown in FIG. 3, the first resistance wiring 51 is at least partially arranged in the inner area 25 which is inside of the maximum circle 22c in the outer base surface inner side wall area 22.

In the example shown in FIG. 3, the entire first resistance wiring 51 is arranged inside of the inner area 25; however, unlike this, part of the first resistance wiring 51 may be arranged in the protruding part 23 which is at the outside of the inner area 25.

Regarding the first resistance wiring 51, a resistance value changes depending on strain caused to the base wall 20. Among the end surfaces (outer base surface) of the metal member 10 including the outer base surface inner side wall area 22, the first resistance wiring 51 is formed on the area where strain is easily generated due to the fluid pressure which is the target to be measured. The resistance value of the first resistance wiring 51 can be detected from the circuit board etc., not shown in the figure via a wiring portion including the electrode pads 52 and wire bonding portions.

The second resistance wiring 53 is at least partially arranged in the protruding part 23. In the example shown in FIG. 3, the entire second resistance wiring 53 or most part of the second resistance wiring 53 is arranged in the protruding part 23. However, unlike this, part of the second resistance wiring 53 may be arranged in the outer base surface side wall area 28. Also, the second resistance wiring 53 may be formed by spanning over the protruding part 23 and the inner area 25. The second resistance wiring 53 may be arranged on a plurality of protruding parts 23.

In the second resistance wiring 53, the resistance value changes due to the temperature of the base wall 20. Among the end surfaces of the metal member 10 including the outer base surface inner side wall area 22 and the outer base surface side wall area 28, the second resistance wiring 53 may be formed in the area where strain is less likely to be generated by the fluid pressure which is the target to be measured. As similar to the resistance value of the first resistance wiring 51, the resistance value of the second resistance wiring 53 can be detected from the circuit board etc., not shown in the figure via a wiring portion including the electrode pads 54 and wire bonding portions.

A detection output by the second resistance wiring 53 is used for a temperature compensation or so of the detection output by the first resistance wiring 51. That is, the detection output by the first detection wire 51 changes depending on strain generated in the base wall 20, and also it is influenced by the temperature change of the base wall 20. Thus, in a pressure sensor which uses the metal member 10, by using the detection output of the second resistance wiring 53 which changes depending on the temperature and only affected slightly by strain, it is possible to remove influence of the temperature included in the detection output by the first resistance wiring 51; thus, a highly accurate pressure detection can be carried out.

Examples of material of the first resistance wiring 51 and the second resistance wiring 53 include metals such as Cr, Ni, Al, Cu, etc.; and, conductive strain resistive films including at least one selected from the group consisting of Cr, Ni, Al, and Cu and at least one selected from the group consisting of N and O. However, the material is not particularly limited to this. Also, a method for forming the first resistance wiring 51 and the second resistance wiring 53 is not particularly limited, and for example, a method mentioned in below may be used. As a first step, an insulation film as a base layer is formed (not shown in FIG. 1 and FIG. 3) on the entire end surfaces including the outer base surface inner side wall area 22 and the outer base surface side wall area 28 of the metal member main part 12. Next, as a second step, a strain resistance film is formed using a thin film method on the insulation film, then the strain resistance film is patterned into a predetermined shape. By going through such steps, the metal member 10 having the first resistance wiring 51 and the second resistance wiring 53 as shown in FIG. 1 and FIG. 3 can be obtained.

As mentioned in above, the metal member for the pressure sensor having the first resistance wiring 51 and the second resistance wiring 53 uses the temperature output of the second resistance wiring arranged on the area with small strain to carry out a highly accurate temperature compensation in regards with the pressure output by the first resistance wiring which is arranged on the area with large strain. Therefore, the pressure sensor using such metal member can accurately detect pressure even when the first resistance wiring is formed using the material with a large resistance temperature coefficient.

As shown in FIG. 1 to FIG. 3, the metal member 10 includes the protruding part 23. Compared to a metal member having an outer base surface inner side wall area of a simple circle shape, even if the thickness of the side wall is the same, the metal member 10 having the protruding part 23 can suppress strain on the outer area of the metal member 10 during pressure detection, thus an enhanced strength can be attained. In other words, because the metal member 10 has the protruding part 23, a section modulus is enlarged compared to the metal member having an outer base surface inner side wall area of a simple circle shape; thus, the metal member 10 with the protruding part 23 can achieve enhanced strength. Therefore, such metal member 10 can make the side wall 30 thinner while ensuring strength.

Also, as shown in FIG. 2, the thickness T1 of the base wall 20 and the thickness T2 of the side wall 30 of the metal member 10 can be about the same. For example, the metal member 10 having the base wall 20 and the side wall 30 with about the same thickness as the thickness T1 and the thickness T2 can be produced using a simple mechanical processing such as a press processing, etc., hence good productivity can be achieved. Also, such metal member 10 is advantageous from the point of achieving light-weight and from the point of achieving a material cost reduction. Note that, for example, in the case that T1/T2 is within a range of 0.9 to 1.1, it is considered that the thickness T1 of the base wall 20 and the thickness T2 of the side wall 30 are about the same.

### EXAMPLES

In below, a metal member according to the present disclosure is explained in further detail using examples. Note that, the characteristics shown in the above-mentioned embodiments and the below described examples are merely examples, and these are not to limit the scope of the present disclosure.

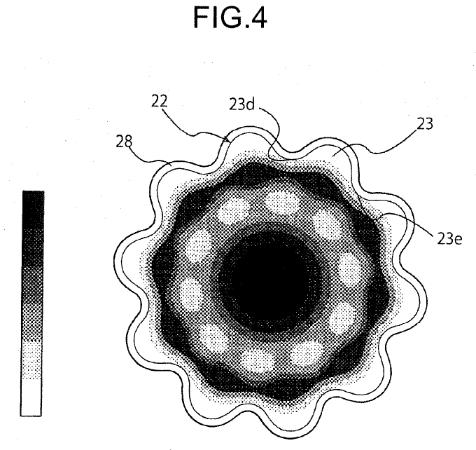

In Example 1, a structural analysis model was prepared which was the same as the metal member main body 12 used in the metal member 10 shown in FIG. 1 to FIG. 3, then the degree of strain generated in each part of the outer base surface inner side wall area 22 was calculated. As a calculation condition of the structural analysis model, stainless steel was used as a material of the metal member main body 12, and a lower surface of a flange part 42 (the surface on the lower side shown in FIG. 2) was used as a fixing surface to apply pressure of 20 MPa to the inside of the metal member 10. FIG. 4 shows the calculation result.

In FIG. 4, the degree of strain generated in each part of the outer base surface inner side wall area 22 which was calculated under the above-mentioned conditions is indicated with different colors. In FIG. 4, as shown in a color scale bar on the left side of FIG. 4, the part having a large strain was indicated in a dark color, and a part having a small strain was indicated in a light color.

As shown in FIG. 4, it was confirmed that the outer area of the metal member 10 including the protruding part 23 had small strain. For example, it can be understood that a part with smaller strain was formed at the inside of the protruding part 23 compared to the first contact point 23d and the second contact point 23e which were the connecting points of the protruding parts 23.

Next, a plurality of structural analysis models was prepared, as similar to the above-mentioned Example 1, in which the structural models had different numbers and shapes of protruding parts 123, 223, 323, 423, and 523 provided to outer base surface inner side wall areas 122, 222, 322, 422, and 522 as shown in metal member main bodies 112, 212, 312, 412, and 512 shown in FIG. 5 to FIG. 9 (Examples 2 to 6). Then, the degree of strain generated in the outer base surface inner side wall area in each example was calculated.

FIG. 5 is an exterior view of the metal member main body 112 according to a structural analysis model of Example 2. The outer base surface inner side wall area 122 of the metal member main body 112 shown in FIG. 5 included twelve protruding parts 123, and an included angle between a first side 123a and a second side 123b of each protruding part 123 was 30 degrees (the number of protruding parts n=12, and the angle was 30-degrees angle).

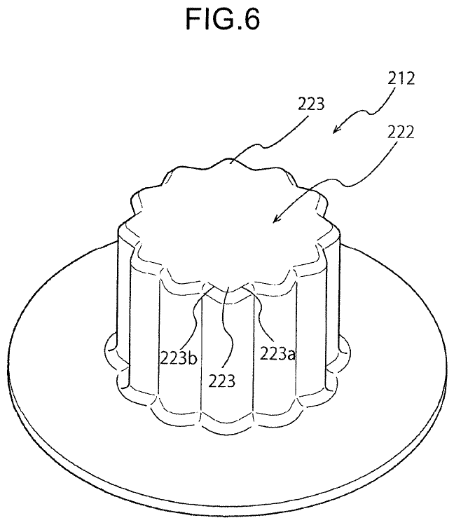

FIG. 6 is an exterior view of the metal member main body 212 according to a structural analysis model of Example 3. The outer base surface inner side wall area 222 of the metal member main body 212 shown in FIG. 6 included twelve protruding parts 223, and an included angle between a first side 223a and a second side 223b of each protruding part 223 was 75 degrees (the number of protruding parts n=12, and the angle was 75-degrees angle).

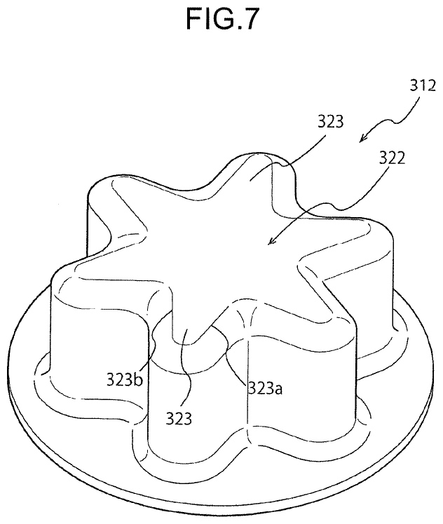

FIG. 7 is an exterior view of the metal member main body 312 according to a structural analysis model of Example 4.The outer base surface inner side wall area 322 of the metal member main body 312 shown in FIG. 7 included six protruding parts 323, and an included angle between a first side 323a and a second side 323b of each protruding part 323 was 30 degrees (the number of protruding parts n=6, and the angle was 30-degrees angle).

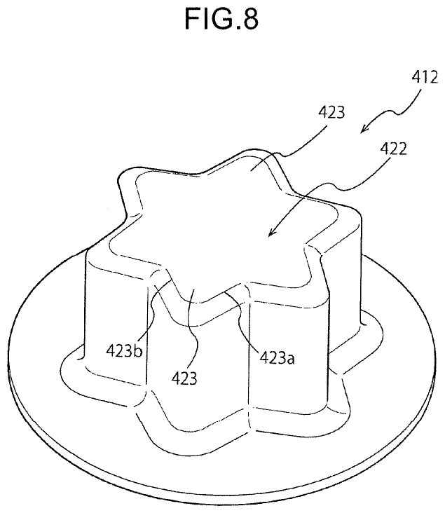

FIG. 8 is an exterior view of the metal member main body 412 according to a structural analysis model of Example 5. The outer base surface inner side wall area 422 of the metal member main body 412 shown in FIG. 8 included six protruding parts 423, and an included angle between a first side 423a and a second side 423b of each protruding part 423 was 60 degrees (the number of protruding parts n=6, and the angle was 60-degrees angle).

FIG. 9 is an exterior view of the metal member main body 512 according to a structural analysis model of Example 6. The outer base surface inner side wall area 522 of the metal member main body 512 shown in FIG. 9 included six protruding parts 523, and an included angle between a first side 523a and a second side 523b of each protruding part 523 was 120 degrees (the number of protruding parts n=6, and the angle was 120-degrees angle).

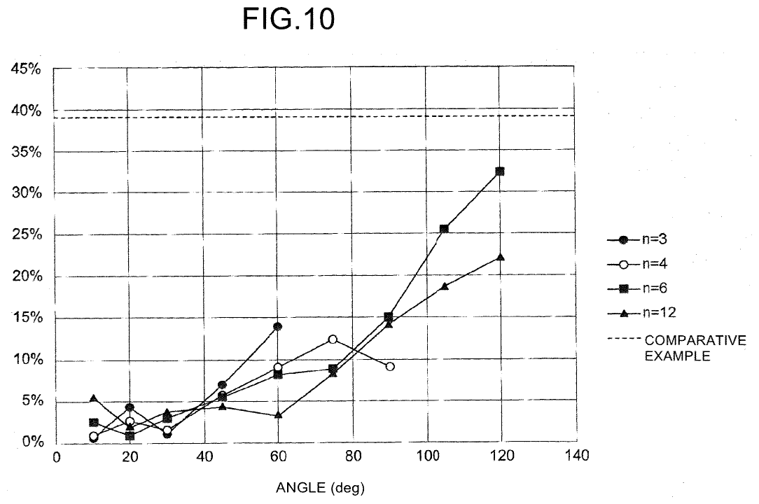

FIG. 10 shows the analysis result of the structural analysis models including Examples 1 to 6. The vertical axis of the graph shown in FIG. 10 is a value obtained by dividing a degree of strain generated in the center part of the protruding part by a degree of strain generated in the center part of the outer base surface inner side wall area (for example, the degree of strain generated in the center part of the protruding part 23 is divided by the degree of strain generated in the center part of the outer base surface inner side wall area 22); and, the smaller this value is, it means that the more suppressed the modification of the protruding part is. Also, the horizontal axis of the graph shown in FIG. 10 is an included angle between the first side and the second side of each protruding part (for example, the included angle between the first side 23a and the second side 23b of the protruding part 23). Also, in FIG. 10, each plot is indicated with different symbols depending on the number of protruding parts included in the metal member main body. Also, as Comparative example, a metal member main body having an outer base surface inner side wall area of a circular shape without any protruding part in plan view was used and the same analysis was carried out. The result of Comparative example is shown by a broken line. Note that, thicknesses of the base wall and the side wall of the models used for Examples and Comparative Example were the same.

As it can be understood from FIG. 10, in the metal member main bodies 12, 112, 212, 312, 412, and 512 having protruding parts (in FIG. 10, n=1 or more), strain of the protruding part was suppressed compared to the metal member main body according to Comparative example. Also, particularly in the area where the included angle between the first side and the second side was 90 degrees or less, the calculation results exhibited that the effect of suppressing strain of the protruding part was even higher.

As understood from above, the present specification discloses the following.

A metal member for a pressure sensor, including:
a base wall and a side wall extending in a direction which crosses with the base wall;
wherein an outer base surface of the base wall comprises an outer base surface side wall area which overlies with the side wall in plan view, and an outer base surface inner side wall area which is positioned inside of and in contact with the outer base surface side wall area and does not overlie the side wall in plan view; and
the outer base surface inner side wall area includes a protruding part existing outside of a maximum circle which can be arranged in the outer base surface inner side wall area in plan view.

The metal member for the pressure sensor according to [1], wherein the protruding part includes a first side extending in a direction away from the maximum circle along a first rotating direction having a center coinciding with a center of the maximum circle in plan view, and a second side extending in a direction towards the maximum circle along the first rotating direction in plan view; and
an included angle between the first side and the second side is 90 degrees or smaller.

The metal member for the pressure sensor according to [1], wherein the protruding part includes a first side extending in a direction away from the maximum circle along a first rotating direction having a center coinciding with a center of the maximum circle in plan view, and a second side extending in a direction towards the maximum circle along the first rotating direction in plan view; and
an included angle between the first side and the second side is 10 degrees or larger.

The metal member for the pressure sensor according to any one of [1] to [3], comprising: a first resistance wiring and a second resistance wiring;
wherein the first resistance wiring is at least partially arranged inside of the maximum circle in the outer base surface inner side area to detect strain of the base wall, and
the second resistance wiring is at least partially arranged in the protruding part to detect a temperature of the base wall

The metal member for the pressure sensor according to any one of [1] to [4], wherein a thickness of the base wall and a thickness of the side wall are about the same.

### Reference Signs Lists

10 . . . Metal member for pressure sensor

12, 112, 212, 312, 412, 512 . . . Metal member main body

20 . . . Base wall

21 . . . Base wall inner surface

22, 122, 222, 322, 422, 522 . . . Outer base surface inner side wall area

22a . . . Outline

22c . . . Maximum circle

22d . . . Center of gravity

23, 123, 223, 323, 423, 523 . . . Protruding part

23a, 123a, 223a, 323a, 423a, 523a . . . First side

23b, 123b, 223b, 323b, 423b, 523b . . . Second side

θ . . . Included angle

23d . . . First contact point

23e . . . Second contact point

25 . . . Inner area

28 . . . Outer base surface side wall area

30 . . . Side wall

32 . . . Side wall outer surface

42 . . . Flange

51 . . . First resistance wiring

52 . . . Electrode pad

53 . . . Second resistance wiring

54 . . . Electrode pad

D1 . . . First rotating direction

T1, T2 . . . Thickness

What is claimed is:

1. A metal member for a pressure sensor, comprising:
a base wall and a side wall extending in a direction which crosses the base wall;
wherein an outer base surface of the base wall comprises an outer base surface side wall area which overlies with the side wall in plan view, and an outer base surface inner side wall area which is positioned inside of and in contact with the outer base surface side wall area and does not overlie the side wall in plan view; and
the outer base surface inner side wall area comprises a protruding part existing outside of a maximum circle which can be arranged in the outer base surface inner side wall area in plan view.

2. The metal member for the pressure sensor according to claim 1, wherein the protruding part comprises a first side extending in a direction away from the maximum circle along a first rotating direction having a center coinciding with a center of the maximum circle in plan view, and a second side extending in a direction towards the maximum circle along the first rotating direction in plan view; and
an included angle between the first side and the second side is 90 degrees or smaller.

3. The metal member for the pressure sensor according to claim 1, wherein the protruding part comprises a first side extending in a direction away from the maximum circle along a first rotating direction having a center coinciding with a center of the maximum circle in plan view, and a second side extending in a direction towards the maximum circle along the first rotating direction in plan view; and
an included angle between the first side and the second side is 10 degrees or larger.

4. The metal member for the pressure sensor according to claim 1, comprising: a first resistance wiring and a second resistance wiring;
wherein the first resistance wiring is at least partially arranged inside of the maximum circle in the outer base surface inner side area to detect strain of the base wall, and
the second resistance wiring is at least partially arranged in the protruding part to detect a temperature of the base wall.

5. The metal member for the pressure sensor according to claim 1, wherein a thickness of the base wall and a thickness of the side wall are about the same.
